(19) United States
(12) Patent Application Publication
(10) Pub. No.: US 2026/0316206 A1
(43) Pub. Date: Oct. 15, 2026

(54) SYSTEM COMPRISING TWO DUST MODULES, INTERFACE FOR CONNECTING THE DUST MODULES, AND METHOD FOR SUCTIONING DUST PARTICLES OUT OF ONE OF THE DUST MODULES

(71) Applicant: Hilti Aktiengesellschaft, Schaan (LI)

(72) Inventors: Markus HARTMANN, Mauerstetten (DE); Rory BRITZ, Starnberg (DE); Rainer ONTL, Landsberg (DE); Oliver OHLENDORF, Landsberg (DE)

(21) Appl. No.: 19/111,044

(22) PCT Filed: Sep. 26, 2023
(86) PCT No.: PCT/EP2023/076461

§ 371 Date: Mar. 12, 2025

(30) Foreign Application Priority Data
Oct. 10, 2022 (EP) 22200634.8

(51) Int. Cl. B23Q 11/00; A47L 7/00; A47L 9/24

(52) U.S. Cl. CPC B23Q 11/0046; A47L 7/0095; A47L 9/24; B23Q 11/0071

(57) ABSTRACT

A system including a first dust module and a second dust module, wherein the first dust module has a first dust collecting container for receiving dust particles and the second dust module has a second dust collecting container for receiving dust particles. At least one of the two dust modules has a non-lockable pneumatic interface for connection to the other dust module, wherein the dust particles can be suctioned via the interface out of the dust collecting container of that dust module which has the interface. In a second aspect, such a non-lockable pneumatic interface for the connection of two dust modules is also provided. In a further aspect, a method for suctioning dust particles out of a first dust module, wherein the first dust module can be connected via the interface to a second dust module, and dust particles can be suctioned from the first dust module into the second dust module.

### BACKGROUND OF THE INVENTION

The present invention relates to a system comprising a first dust module and a second dust module, wherein the first dust module has a first dust collecting container for receiving dust particles and the second dust module has a second dust collecting container for receiving dust particles.

In the prior art, dust collecting boxes are known which can be connected to a power tool in order to suction away dust that is generated when work is performed using the power tool, and to do so directly in the working area of the power tool or of the tool thereof. Such dust collecting boxes commonly have a dust collecting container that must be emptied at regular intervals. It is common for the dust collecting containers of conventional dust collecting boxes, such as are known from the prior art, to be emptied by virtue of the entire dust collecting box, or its dust collecting container, being removed from the power tool in order to dispose of the contents of the dust collecting container.

### SUMMARY OF THE INVENTION

A disadvantage of the known solutions for emptying the dust collecting boxes is that the user of the system consisting of power tool and dust collecting box is commonly exposed to very high levels of dust, which is undesirable. For example, if the contents of the dust collecting container are poured out or transferred into another container, the dust may disperse in the surroundings of the user, with the result that the user and the surroundings are exposed to high levels of dust. Tests examining user behavior have furthermore found that the dust collecting containers or dust collecting boxes are often beaten out when being emptied, for example by being struck against the container that is intended to receive the contents of the dust collecting container. Such an approach poses a great risk in particular to the sensitive parts of the dust collecting box, such as the filter, because damage to the sensitive components can occur. There is also the possibility of the dust collecting boxes not being reassembled again entirely correctly, or not being installed entirely correctly on the power tool. Such instances of possible improper assembly pose a further risk of damage to the conventional dust collecting boxes such as are known from the prior art. Instances of improper assembly can disadvantageously shorten the service life of the dust collecting box or of its components.

In order to overcome the described disadvantages and defects, the prior art has also disclosed solutions in which the dust collecting box or its collecting container are fixedly connected to an external vacuum cleaner. It has however been found that such frictional and/or form-fitting connections between the dust collecting box or dust collecting container, on the one hand, and the external vacuum cleaner, on the other hand, can also lead to difficulties. For example, consequential damage can occur in particular to the filter system of the dust collecting box if a user erroneously attempts to additionally assist the evacuation of the dust collecting box by suction using the external vacuum cleaner, with the apparent intention of increasing the total suction power by activating the external vacuum cleaner.

Furthermore, very high loads can occur at the mechanical interface between dust collecting box and external vacuum cleaner. The suction hoses that are used on construction sites or in the field of industrial or construction-site vacuum cleaners are often very long and heavy, commonly also owing to adherent dirt or slurry. This starting situation leads to various problems and challenges. For example, the long hoses that are connected to the dust collecting box and thus to the power tool in the case of a fixed mechanical connection constitute a safety risk in the sense that they are trip hazards. Furthermore, the suction hose can become caught on obstructions on the construction site, with the result that the forces acting on the mechanical interface become very high and the suction hose can possibly even break away from the interface. It has been found that the high mechanical loads can lead to short service lives of the frictional and/or form-fitting fixed interfaces. Furthermore, both the connection between the power tool and dust collecting box and the connection between the dust collecting box and the external vacuum cleaner can sustain damage or be mechanically impaired in some other way.

In some cases, very heavy and voluminous interface solutions have been proposed in response to these problems and in order to produce particularly robust, durable and stable connections between the components in question. Such heavy and voluminous interface solutions have however proven to be of little use in practice because, owing to the high weight and/or the large volume, they can make the power tool much more difficult to handle. It has furthermore been found that the production of such heavy and voluminous interface solutions can be expensive and material-intensive.

For example, EP 4 005 452 A1 discloses a cleaning device having a vacuum cleaner and a docking station, wherein the docking station is designed to automatically take in dust from the vacuum cleaner.

WO 2009 019 057 A1 has described a handheld power tool having a dust suctioning device, wherein a dust box of the dust suctioning device has an adjustable closing flap that can be opened in the direction of the dust box.

DE 10 005 976 A1 describes a handheld power tool having a dust suctioning means that can be connected to a dust box. The dust box can be closed using closing flaps, wherein the closing flaps project into the interior of the dust box.

is an object of the present invention to overcome the above-described defects and drawbacks of the prior art and to provide a dust suctioning system in which the dust collecting container of a dust module can be emptied in particularly straightforward and uncomplicated fashion. Furthermore, the emptying of the dust collecting container should be as dust-reduced or dust-free an operation as possible, and minimize the exposure of the user to dust. Furthermore, the dust suctioning system that is to be provided should be as easy and convenient to use and to handle, and should not pose a safety risk to the user.

The present invention provides a system comprising a first dust module and a second dust module is provided, wherein the first dust module has a first dust collecting container for receiving dust particles and the second dust module has a second dust collecting container for receiving dust particles. At least one of the two dust modules has a non-lockable pneumatic interface for connection to the other dust module, wherein the dust particles can be suctioned via the interface out of the dust collecting container of that dust module which has the interface.

In the context of the invention, the term “non-lockable” preferably means that the pneumatic interface is activated by a pressing force applied by the user, and is deactivated owing to the absence of a pressing force applied by the user. In other words, the “non-lockable” pneumatic interface can be activated by application of a pressing force. Alternatively or in addition, the “non-lockable” pneumatic interface can be deactivated when a pressing force is absent, that is to say a user of the proposed system does not apply a pressing force in order to bring the two dust modules into contact with one another or mechanically connect them. With this pneumatic interface which can be activated by a pressing force applied by the user and can be deactivated by the absence of a pressing force applied by the user, the invention departs from the prior art, which predominantly describes dust modules that are fixedly, that is to say permanently, connected to one another or dust modules in which the temporary contact between the dust modules is effected or stabilized by means of gravitational force.

Contrary to such solutions based on gravitational force, the connection between the dust modules in the context of the present invention is based on a pressing force that has to be applied by the user in order to establish and maintain the connection between the dust modules. Rather, in the context of the invention, it is preferred that the dust modules are not connected to one another whilst the first dust module or a power tool to which the first dust module is fastened is in operation. Therefore, in the context of the present invention, the term “non-lockable” is to be understood to mean that the connection between the dust modules that is imparted by the pneumatic interface does not exist permanently, and/or that said connection is based not on gravitational force but on a pressing force that must be imparted by the user. In the context of the invention, it is preferred that, when such a pressing force is applied, the pneumatic interface is activated such that a suction flow can pass through, whereas the pneumatic interface is deactivated when no pressing force is applied. The pneumatic interface is then closed, and no exchange occurs between the dust modules because the fluidic connection between the dust modules is shut off or is blocked by the deactivated pneumatic interface.

It has been found that, specifically in the case of multi-part dust systems, there is the risk of improper use by the user. For example, the user may initiate static suctioning via the dust modules, which can lead to mechanical overloading of the pneumatic interface between the dust modules. Such improper use is prevented in an effective manner by the invention, because the dust modules are specifically not connected to one another whilst in operation. Rather, a pressing force must be imparted by the user in order to establish and maintain the connection between the dust modules by means of the pneumatic interface. Only when a pneumatic interface is active is the interface passable to the suction flow, and it is only in this case, that is to say when a pressing force is applied by the user, that dust can be suctioned through the pneumatic interface.

The invention relates to a system having a first dust module and having a second dust module, wherein the first dust module has a first dust collecting container for receiving dust particles and the second dust module has a second dust collecting container for receiving dust particles. At least one of the two dust modules has a pneumatic interface for connection to the other dust module, wherein the dust particles can be suctioned via the interface out of the dust collecting container of that dust module which has the interface, wherein the pneumatic interface can be activated by a pressing force applied by the user and deactivated owing to the absence of a pressing force applied by the user.

The system has a further safety-relevant advantage. According to the invention, provision is made for at least one of the two dust modules to have a non-lockable pneumatic interface for connection to the other dust module, wherein the dust particles can be suctioned via the interface out of the dust collecting container of that dust module which has the interface. The term “non-lockable” preferably also encompasses that the user of the system must apply a pressing force in order to activate the interface between the dust modules. When, according to one exemplary embodiment of the invention, a dust module has been connected to a power tool, the user of the system generally needs to use two hands to safely operate the power tool. However, this leaves no hand free to hold the second dust module. This advantageously has the effect that it is not possible to simultaneously operate the power tool and evacuate one dust module by suction by means of the other dust module. In other words, improper use of the proposed system can be prevented in an effective manner by the non-lockable interface. Improper use may for example consist in the power tool being arranged on one dust module and a second dust module being operated simultaneously in order to evacuate the first dust module by suction, wherein damage can occur to the dust modules and/or to the interface. This is the case in particular because the dust modules and/or the interface can be subject to intense vibration loads if a dust module is emptied, and work is performed using the power tool, simultaneously. Another form of improper use may for example consist in the two dust modules being operated simultaneously. This further form of improper use can also be prevented in an effective manner by means of the invention and owing to the provision of the “non-lockable” interface between the dust modules.

Aside from the prevention of mechanical damage to the dust modules and/or to the interface as a result of improper use, the invention also makes it possible to prevent the user of the proposed system from being exposed to high levels of dust. This is because, since the user is forced to evacuate a dust module by suction, or empty a dust module, only when work is not being performed using the power tool to which the dust module can be fastened, an undesired release of dust into the surroundings of the user of the proposed system can be prevented in an effective manner. In this way, the surroundings of the user are kept free from dust, and the user is in particular not subject to undesired dust exposure. It has therefore been found that, with the invention and through the provision of the “non-lockable” interface between the dust modules, simultaneous operation of a dust module, on the one hand, and of the power tool or of the other dust module, on the other hand, can be prevented in an effective manner. This simultaneous operation can lead to damage to the system and to the user being exposed to high levels of dust, and it is therefore a major advantage of the system that such improper use—owing to simultaneous operation of power tool and dust module or of dust module and dust module—can be prevented in a particularly effective manner. The basis for this is in particular the requirement for the pressing force that is needed to activate the pneumatic interface between the dust modules.

With the invention, particularly dust-reduced or dust-free emptying of a dust module can be ensured. Additionally, the effort required on the part of the user of the system to empty the dust collecting container can be considerably reduced by means of the invention, because neither the dust collecting container nor the dust module has to be uninstalled or dismantled. Furthermore, the dust collecting container can be emptied without the need for the dust collecting container or other components of the dust module to be beaten out or shaken out. Damage to the dust module can thus be avoided, and its service life can be greatly lengthened. The non-lockable pneumatic interface will hereinafter preferably also be referred to for simplicity as “interface”.

In the context of the invention, it is very particularly preferred that the interface is present or arranged between the dust collecting container of one dust module and an inlet of the other dust module. It can be ensured in this way that the dust particles can be suctioned out of that dust module which has the interface. For example, the non-lockable pneumatic interface may be part of the first dust module. In other words, in this exemplary embodiment of the invention, the first dust module has the non-lockable pneumatic interface, by means of which the first dust module can be connected to the second dust module. In the context of the invention, it is very particularly preferred that the (first) dust collecting container of the first dust module can be connected to the inlet of the second dust module. It is then possible for the dust particles that are situated in the (first) dust collecting container of the first dust module to be suctioned out of the first dust module, and suctioned into the second dust module, via the interface. Here, the dust particles may be suctioned out of the first dust module in particular into the dust collecting container of the second dust module. In other words, dust particles can be transferred from the first into the second dust module.

In the context of the invention, the term “non-lockable” means that the first and the second dust module are not connected to one another whilst the first dust module, or a power tool to which the first dust module is fastened, is in operation. When it is intended to empty the dust collecting container of the first dust module, it is for example possible for a first end of a suction hose of the second dust module to be brought into contact with the interface of the first dust module, and the interface thus made passable to the dust particles (“opening of the interface”). When the interface is open, dust particles can pass from the first dust module into the second dust module, wherein the dust particles can in particular be suctioned from the first into the second dust module. The opening of the interface may preferably also be referred to in the context of the invention as “pneumatic activation of the interface”. In the context of the invention, it is preferred that dust particles can be transferred from the first into the second dust module through a pneumatically activated interface. Preferably, in the case of a non-lockable interface, a connection that is passable to dust particles exists between the two dust modules only for as long as one dust module is pressed with a pressing force against the other dust module. In the context of the invention, it may also be preferred that components of the dust modules are brought into close contact with one another or pressed against one another. The first end of the suction hose, which can be brought into close contact with the interface, may preferably also be referred to in the context of the invention as an inlet contact of the second dust module. In context of the invention, it is very particularly preferred that the non-lockable pneumatic interface can be pneumatically activated, that is to say opened, by way of close contact and/or a pressing force. The interface is preferably automatically closed again as a result of the close contact being ended or eliminated, wherein such an interface is preferably referred to in the context of the invention as a “self-closing” interface.

It may also be preferred in the context of the invention for the interface to be manually opened. For example, it is possible for the interface to be closed by means of a cover, which is removed before the suctioning and which is refitted after the suctioning operation has been ended.

To simplify the description, it will hereinafter be assumed that at least the first dust module has a non-lockable pneumatic interface, which can be brought into close contact with an inlet contact of the second dust module in order that a suction channel is created and dust can be suctioned out of the dust collecting container of the first dust module. In the context of the invention, it is preferred that the non-lockable pneumatic interface is configured to establish a suction channel between the first dust module and the second dust module. The suction channel preferably exists only for as long as a pressing force is exerted between the first dust module and the second dust module. In the context of the invention, it is very particularly preferred that, by means of the non-lockable pneumatic interface, a suction channel can be established between the first dust module and the second dust module, via which suction channel dust particles can be suctioned out of the first dust module into the second dust module. In other words, a suction channel can exist between the first dust module and the second dust module in order for dust particles to be exchanged between the dust modules or in particular to be transferred from the first dust module into the second dust module. Said suction channel may preferably run through the interface of the first dust module.

For example, the second dust module may be connected to a suction hose, wherein the first end of the suction hose constitutes a free end of the suction hose, and wherein said first end of the suction hose can be connected to a power tool, to a suction nozzle or the like. In the context of the invention, it is preferred that the first, front end of the suction hose is referred to as an inlet contact of the second dust module. The second end of the suction hose may preferably be connected to the second dust module via an inlet, in particular via an inlet opening. For example, the second end of the suction hose may open into an inlet opening of the (second) dust collecting container of the second dust module, such that dust particles can be suctioned into the dust collecting container of the second dust module by means of the suction hose. In the context of the invention, it is preferred that the first end of the suction hose is referred to as a front end, and the second end of the suction hose is referred to as a rear end, of the suction hose. In this exemplary embodiment of the invention, the first, front end of the suction hose can be connected to the non-lockable pneumatic interface of the first dust module, and dust particles can be transferred from the first dust module into the second dust module. For this purpose, the dust particles can be suctioned out of the (first) dust collecting container of the first dust module via the pneumatically activated interface of the first dust module, and via the suction hose which is for example connected to the second dust module, into the dust collecting container of the second dust module. The interface may preferably be pneumatically activated by virtue of the first end or the inlet contact of the suction hose being brought into close contact with the interface, such that, as a result of said contact, the interface is made passable to dust particles. In the context of the invention, it is preferred that a pressing force is exerted by the suction hose of the second dust module on the first dust module or the interface, wherein the pressing force has the effect that the interface is opened and made passable, in order to “pass through” dust particles from the first dust module into the second dust module. As a result of the close contact between the first end of the suction hose and the first dust module or the interface thereof, a suction channel can advantageously be created via which dust particles can be suctioned out of the first dust module and transferred into the second dust module. A stream of dust-laden air can preferably flow through said suction channel, wherein the dust particles can pass with this air stream from the first dust module into the second dust module.

In the context of the invention, it is preferred that a sealing force direction of the interface corresponds to a direction of the pressing force between the dust modules. For example, the interface of the first dust module may comprise a spring element that can be compressed by the inlet contact of the second dust module in order to open up the path for the dust-laden air through the interface. If the inlet contact of the second dust module, which is formed for example by the front end of the suction hose between the dust modules, is brought into close contact with the interface of the first dust module, the spring element can be compressed and a valve in the interface can be opened up, such that the dust-laden air can be drawn through the interface. In the state of contact, in which the interface is passable and the interface is in close contact with the inlet contact of the second dust module, a virtual central axis runs through the interface and the inlet contact. In the context of the invention, it is preferred that both the sealing force direction of the interface and the direction of the pressing force run along this virtual central axis. The sealing action within the interface is preferably effected in that, as the close contact is established between the first and the second dust module, the inlet contact is pushed in the direction of interior space of the first dust module. This preferably has the result that the sealing force direction of the interface and the direction of the pressing force between the dust modules point in substantially opposite directions, wherein the sealing force direction and the direction of the pressing force between the dust modules preferably coincide with the virtual central axis through the interface and/or through the inlet contact.

It is furthermore preferred in the context of the invention that the interface is of self-closing design. In the context of the invention, this preferably means that the interface is closed in the absence of external action and can be pneumatically activated, that is to say opened, for example as a result of close contact or a pressing force. This close contact may preferably be effected by way of contact between the interface and the inlet contact of the second dust module or of its suction hose. The inlet contact may for example also exert the pressing force on the interface, wherein the pressing force causes the interface to open. In the context of the invention, it is very particularly preferred that the interface closes automatically when the inlet contact of the second dust module is removed from the region of the interface. The interface is preferably not held open, that is to say so as to be passable to dust, of its own accord, with the interface rather preferably automatically closing when a pressing force is no longer being exerted on the interface, that is to say when there is no longer close contact between the first and the second dust module. In the context of the invention, it is preferred that the suction channel between the dust modules is not maintained or held open in the absence of external action. In particular, in the context of the present invention, no device, no frictional contact or no pneumatic force is provided which holds the interface or the suction channel open when no pressing force is being exerted or when there is no close contact between the dust modules. In the context of the invention, it is preferred that the interface is neither frictionally nor cohesively lockable.

In context of the invention, it is preferred that the non-lockable pneumatic interface can be pneumatically activated by way of close contact and/or a pressing force. In context of the invention, it is very particularly preferred that the non-lockable pneumatic interface can be mechanically opened by way of the close contact and/or the pressing force. The close contact may exist in particular between an interface of the first dust module and an inlet contact of the second dust module. Preferably, the pressing force may be exerted by the inlet contact of the second dust module on the interface of the first dust module. Alternatively or in addition, the non-lockable pneumatic interface may be pneumatically opened by a negative pressure of the second dust module. In this refinement of the invention, the interface can be opened by the negative pressure that can be generated in the second dust module in order to draw in dust. For this purpose, that dust module which comprises the interface may for example have a valve that can be preloaded. In the context of the invention, it is preferred that the valve is configured as a check valve and is provided in the region of the interface of that dust module which has the interface. In the context of the invention, it may however also be preferred that the valve is formed by a duckbill valve. The use of duckbill valves has proven to be advantageous in the context of the present invention, because duckbill valves firstly close substantially without friction and are secondly self-assisting, wherein the negative pressure can boost the sealing action of the valves.

It is preferred in the context of the invention that the check valve is of multi-part form. A check valve of multi-part form may preferably have a plastics part, a seal and a spring element. The plastics part may be movable and, in the actuated state, open up the path or the suction channel in order that the dust particles can be suctioned from the first dust module into the second dust module. The seal may be configured to seal off the suction channel when the interface and/or the check valve are/is closed. The spring element may generate a preload, which can preferably contribute to the interface being of self-closing design and closing again of its own accord when no pressing force is being transmitted from the inlet contact of the second dust module to the first dust module, that is to say when there is no close contact between the dust modules.

In the context of the invention, the check valve may preferably also be of single-part form. In this case, the check valve may comprise a single-part elastomer component that has both a sealing action and function and a spring action and function. If the check valve is of single-part form, it can advantageously combine the various actions and functions that the check valve is intended to perform into one part, specifically the elastomer component. The construction and assembly of the interface can thus be kept straightforward.

It has been found that the interface makes it possible, without uninstallation and in dust-free and damage-free fashion, for the dust particles to be suctioned out of that dust module which has the interface. In other words, by means of the interface, the dust collecting container of that dust module which has the interface can be emptied without uninstallation and in dust-free and damage-free fashion, such that the first dust module, after being emptied, can continue to be operated for example in order to suction dust out of a working area of a power tool. In particular, with the invention, it can be ensured that the dust collecting container of that dust module which has the interface can be emptied particularly easily and safely, whilst at the same time an inexpensive, compact and lightweight structural form of the dust module is provided.

In the context of the invention, it is preferred that the first dust module is a dust collecting box on a power tool. Such dust collecting boxes are known per se in the prior art and can for example be connected to hammer drills in order to suction away the dust that is generated when work is performed using the power tool. The dust is generated primarily in a working area of the power tool or of its tool, wherein a suction pipe may be arranged between the dust collecting box and the working area of the power tool. The dust collecting box may for example have a suction appliance by means of which a negative pressure can be generated, which negative pressure can be used to draw in dust and dirt. The dust collecting box may for example be arranged on an underside of the power tool. In the context of the invention, it is preferred that the power tool on which the dust collecting box can be arranged whilst the power tool is in operation is not a constituent part, or is an optional constituent part, of the proposed system. By contrast, the required constituent parts of the system are the first dust module, the second dust module and the non-lockable pneumatic interface, which is arranged at least on one of the dust modules. In the context of the invention, it may also be preferred for all of the dust modules of the system to have a non-lockable pneumatic interface. In the case of this refinement of the invention, the term “non-lockable” means that the first and the second dust module are not connected to one another whilst the first dust module, or the power tool to which the first dust module can be connected, is in operation.

In the context of the invention, it is preferred that an assembled state of the system corresponds to a working state of the system. In the context of the invention, this preferably means that the particles can be transferred from the first into the second dust module (“working state”) in particular when the two dust modules have been connected to one another (“assembled state”). The term “working state” is preferably independent of a working state of the power tool.

The second dust module be formed for example by an industrial or construction-site vacuum cleaner, preferably referred to in the context of the invention as a “separate vacuum cleaner”. Industrial or construction-site vacuum cleaners are likewise known per se, and commonly have a suction appliance, such as a turbine, in order to generate a negative pressure and thus a suction flow. The suction appliance may be driven by a motor of the industrial or construction-site vacuum cleaner. Dust or the like can be drawn into a dust collecting container by way of the suction flow. For this purpose, the industrial or construction-site vacuum cleaner may comprise a suction hose, which can be connected by way of its first, front end to a power tool or to a suction nozzle and by way of its second, rear end to the industrial or construction-site vacuum cleaner or the vacuum cleaner head or dust collecting container thereof. Furthermore, the industrial or construction-site vacuum cleaner may have filters for cleaning the suction flow and for protecting the motor and/or the suction appliance of the industrial or construction-site vacuum cleaner. The dust collecting container of the second dust module (“second dust collecting container”) preferably has a greater volumetric capacity than the dust collecting container of the first dust module (“first dust collecting container”). In this way, the emptying of the first dust collecting container or the suctioning of dust particles out of the first dust module can be repeated without the need to empty the second dust collecting container. The second dust module can consequently be used as a large collecting container for dust on a construction site. In the context of the invention, it may also be preferred for a multiplicity of power tools with a multiplicity of first dust modules to be used on one construction site. The multiple first dust modules may each have a non-lockable pneumatic interface and be emptied into the dust collecting container of the second dust module. For example, the first dust module may also be designed as a vacuum cleaner robot, such that the second dust module may serve as a base station for receiving dust particles. In the context of the invention, it may also be preferred that the proposed system comprises not only a second dust module but also a first dust module, which is designed as a dust collecting box for a power tool, and a further first dust module, wherein the further first dust module is designed as a vacuum cleaner robot. The first dust modules each comprise a first dust collecting container having a non-lockable pneumatic interface, wherein the dust collecting containers of the first dust module can, via the interface, be emptied in particularly straightforward, dust-free and uncomplicated fashion into the second dust module. Consequently, with the invention, a system can be provided for particularly dust-reduced or dust-free disposal of dust or dust particles from relatively small, preferably mobile first dust modules, wherein the emptying is performed into a second, preferably larger dust module.

In one exemplary embodiment, the invention may be a system consisting of at least two dust modules, wherein the dust modules each have collecting containers, wherein at least one first dust module has a non-lockable pneumatic interface, situated on the collecting container, as an inlet interface for a further dust module. The collecting container may preferably be arranged between the inlet interface and a filter of the dust module. In the context of the invention, it is preferred that the filters of the “subsequent” dust modules have progressively increasing particle retention capacities. In other words, the filter of the second dust module is preferably configured to accommodate more dust than the filter of the first dust module. In the context of the invention, the dust modules may preferably also be referred to as vacuum cleaner modules.

The present invention consists in particular in that at least one of the two dust modules, for example the first dust module, has a non-lockable pneumatic interface, by means of which the dust collecting container of that dust module which has the interface can be evacuated by suction. In this context, the expression “evacuation by suction” preferably means that the dust collecting container of that dust module which has the interface can be emptied by means of the interface in that the dust particles situated in the dust collecting container can be suctioned away, or transferred, via the pneumatically activated interface into the dust collecting container of the other dust module, which for example has no non-lockable pneumatic interface. A transfer of the dust particles thus preferably takes place, specifically preferably from the relatively small dust collecting container of the first dust module, which in this exemplary embodiment has the interface, into the relatively large dust collecting container of the second dust module.

In the context of the invention, it is very particularly preferred that the proposed system has a dust collecting box for a power tool as a first dust module and has an industrial or construction-site vacuum cleaner as a second dust module, wherein at least the dust collecting box has a non-lockable pneumatic interface in order that dust particles can be suctioned out of the dust collecting container of the dust collecting box via the interface into the dust collecting container of the industrial or construction-site vacuum cleaner. In one exemplary embodiment of the invention, the first dust module of the proposed system is a dust collecting box for a power tool, and the second dust module is a separate vacuum cleaner. Here, at least the first dust module may have the non-lockable pneumatic interface, wherein the non-lockable pneumatic interface is situated in the dust collecting container of the first dust module. In the context of the invention, it is preferred that that dust module which has the non-lockable pneumatic interface can be emptied via the interface without having to be uninstalled. The dust module that has the non-lockable pneumatic interface is preferably the first dust module, which, by means of the invention, can be emptied in particularly straightforward and dust-reduced or dust-free fashion. If, for example, the first dust module has the non-lockable pneumatic interface, this feature preferably means, in the context of the invention, that the first dust module does not need to be dismantled in order to be emptied. In particular, it is not necessary to remove the dust collecting container, or any filter unit that may be present, from the dust module. Rather, the first dust module can be emptied by way of close contact with the second dust module, or by virtue of a pressing force being exerted on the first dust module by the second dust module or one of its components. This is because, owing to the close contact or the pressing force, the interface between the dust modules can be opened such that a suction channel is created between the dust modules. The dust particles can then pass through this suction channel from the first dust module into the second dust module, such that the first dust module or its dust collecting container can be emptied or evacuated by suction. In this way, it is possible by means of the invention to provide a very time-saving and uncomplicated facility for emptying a dust module, for example a dust collecting box for a power tool. In the context of the invention, if the first dust module is formed by a dust collecting box for a power tool, it is in particular not necessary to remove the dust collecting box from the power tool when it is intended to empty the dust collecting container of the dust collecting box. Rather, the dust collecting container can advantageously remain on the dust collecting box, such that the operation of the power tool can be continued or resumed particularly quickly.

In the context of the invention, it is preferred that the dust collecting box can be emptied both whilst the power tool is in operation and when the power tool has been switched off. The dust collecting box is preferably emptied when the dust collecting box has been switched off, because in this state, the emptying operation can be combined with a filter cleaning operation. Such an approach is expedient because, when the dust collecting box has been switched off, back-flushing is possible, in the case of which an air stream flows through the filter, the air stream being configured to release any filter cake from the filter. Working with the power tool can thus be made easier and more efficient.

It is preferred in the context of the invention that the non-lockable pneumatic interface is of self-closing design. This can be made possible, as described above, for example through the provision of a preferably preloadable check valve. In context of the invention, it is very particularly preferred that the non-lockable pneumatic interface comprises a valve for opening up or for closing the suction channel. In the context of the invention, the term “self-closing” preferably means that the interface allows dust and dust-laden air to pass through the interface when there is close contact between the inlet contact of the second dust module and the interface of the first dust module, wherein the interface closes virtually automatically when the inlet contact of the second dust module is removed from the interface region of the first dust module and the close contact between the dust modules is thus eliminated. In the context of the invention, it is preferred that the valve or its spring element is preloaded during the normal suctioning operation of the dust collecting box, and is open counter to the preload, owing to the close contact between the dust modules, when the dust collecting box is being emptied.

For example, the inlet contact of the second dust module may be formed by a front end of a suction hose, which can be introduced into an opening of the interface of the first dust module. Here, a pressing force may be exerted on the interface, by way of which pressing force the valve is opened counter to the preload. The interface is thus opened whilst the valve is in the braced state, such that, in this opened state (“working state of the interface”), dust and/or dust-laden air can pass through the interface from the first into the second dust module. In other words, the interface can be opened by virtue of the valve being transferred from a preloaded or initial position into a braced state, wherein the braced state of the valve preferably corresponds to the working or opened state of the interface. By virtue of the suction hose being pulled out of the opening of the interface, the close contact between the dust modules, and the working state, can be ended by virtue of the valve relaxing owing to the absence of the inlet contact and said valve quickly returning from the braced state into its initial or preloaded position.

According to the invention, it is preferred that the preload of the valve can have different functions. Firstly, the preload is preferably used for closing the valve. Here, in the context of the invention, it is preferred that the valve is returned substantially fully from the opened state into the closed state. Owing to the preload, and in order to preferably substantially fully close the valve, friction can advantageously be overcome by means of the invention, wherein overcoming the friction requires a force that is preferably greater than zero. Furthermore, by means of the preload, the valve can be prevented from undesirably opening of its own accord. This is because an opening force acts on the valve owing to the negative pressure in the dust box, wherein the preload of the valve counteracts the negative pressure.

In a second aspect, the invention relates to a pneumatic interface between a first dust module and a second dust module, wherein the interface is of non-lockable design. The terms, definitions and technical advantages introduced for the system preferably apply analogously to the pneumatic interface. The pneumatic interface may preferably be of self-closing design and configured to establish a suction channel between the first dust module and the second dust module. In other words, by means of the non-lockable pneumatic interface, a suction channel can be established between the first dust module and the second dust module, via which suction channel dust particles can be suctioned out of the first dust module into the second dust module. The non-lockable pneumatic interface may preferably comprise a check valve for opening up or for closing the suction channel, wherein the check valve may be of single-part or multi-part form. In the context of the invention, it is preferred that the non-lockable pneumatic interface can be pneumatically activated by way of close contact and/or a pressing force, wherein the non-lockable pneumatic interface is provided in the dust collecting container of the first dust module of the proposed system.

In a further aspect, the invention relates to a method for suctioning dust particles out of a first dust module, wherein the first dust module is a constituent part of the proposed system. The terms, definitions and technical advantages introduced for the system and the pneumatic interface preferably apply analogously to the suctioning method. The method for suctioning dust particles is characterized by the following method steps:
a)providing a first dust module, wherein at least the first dust module has a non-lockable pneumatic interface for the connection of the first dust module to a second dust module,
b) connecting the first dust module to the second dust module via the interface,
c) suctioning dust particles out of the first dust module by means of the interface.

In the context of the invention, it is very particularly preferred that the dust particles are suctioned via the interface from the first dust module into the second dust module, wherein the interface can be opened by virtue of a pressing force being exerted, and/or by way of close contact, between the interface of one dust module, on the one hand, and an inlet contact of the other dust module, on the other hand. When the interface is open, a suction channel can be formed between the first dust module and the second dust module, via which suction channel dust particles can be suctioned from the dust collecting container of the first dust module into the dust collecting container of the second dust module. For this purpose, a pressure difference may preferably exist between the dust modules. In the context of the invention, it is very particularly preferred if a stronger negative pressure prevails in the second dust module then in the first dust module when the interface is open. Owing to this pressure difference, the dust particles can be suctioned out of the dust collecting container of the first dust module and into the dust collecting container of the second dust module. In the context of the invention, the wording “a stronger negative pressure” preferably means that, expressed in absolute numbers, a lower pressure prevails in the second dust module than in the first dust module. This arises from the fact that the negative pressure is stated in negative numbers, such that a “stronger negative pressure” is associated with a greater separation from a pressure of p=0 bar. For example, the negative pressure in the second dust module may be −100 millibars (mbar), whereas the negative pressure in the first dust module is for example −50 mbar. If the interface is opened, that is to say pneumatically activated, under such pressure conditions, the dust particles are suctioned from the first into the second dust module owing to the pressure difference. In other words, under these pressure conditions, the suction channel forms such that a pressure equalization flow occurs from the first into the second dust module, with which pressure equalization flow the dust particles can be transported from the first into the second dust module.

In the context of the invention, it is preferred that the first dust module and the second dust module have filters by means of which the air stream or suction stream can be cleaned. By means of the filters, the air of the suction stream can be cleaned of dust and the like, such that only cleaned and/or filtered air flows through the suction appliance. It is thus advantageously possible for the service life of the suction appliance to be lengthened, because the suction appliance and its components are protected against contamination and damage in an effective manner owing to the provision of the filter. In the context of the invention, it is very particularly preferred that the filter of the second dust module (“second filter”) has a greater dust retention capacity than the filter of the first dust module (“first filter”). In the context of the invention, this preferably means that the dust-laden air stream can be cleaned of dust and dust particles in a particularly effective manner in particular in the second dust module.

In the context of the invention, it is preferred that the second dust module has an inlet contact which can be brought into close contact with the non-lockable pneumatic interface of the first dust module such that a suction channel is formed between the first dust module and the second dust module.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form sensible further combinations.

Identical and similar components are denoted by the same reference signs in the figures. In the figures:

FIG. 1 shows a view of a preferred refinement of the system

FIG. 2 shows a sectional illustration of a preferred refinement of the first suction module

FIG. 3 shows a sectional illustration of a preferred refinement of the pneumatic, non-lockable interface

FIG. 4 shows an illustration of a preferred refinement of the system having a first and a second suction module

FIG. 5 shows an illustration of a preferred refinement of the system having a first, a second and an n-th suction module

### DETAILED DESCRIPTION

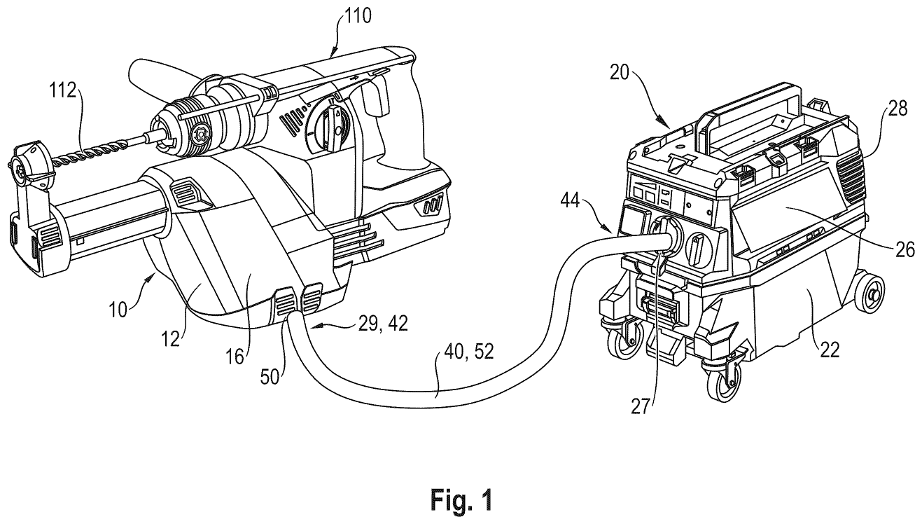

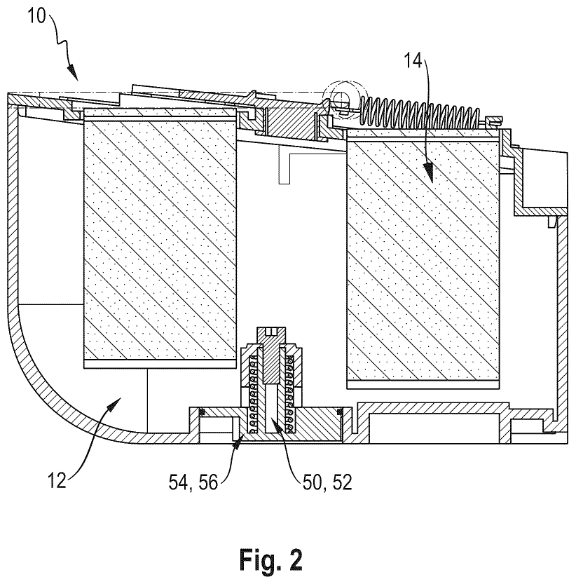

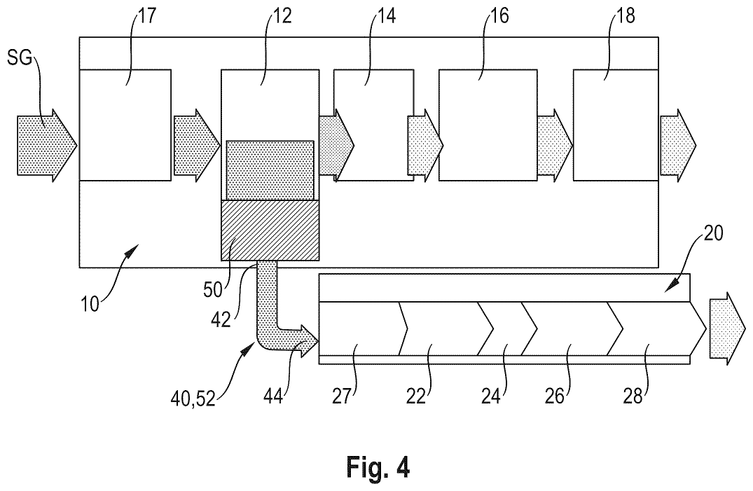

FIG. 1 shows a preferred refinement of the system 100. The illustration shows a power tool 110 having a tool 112. The power tool 110 may for example be a hammer drill or chisel hammer, wherein the tool 112 of the power tool 110 can be used to machine a substrate. When work is performed using the power tool 110, dust may be generated in a working area, that is to say where the tool 112 of the power tool 110 machines the substrate. The dust may also include relatively large particles, wherein the mixture of dust and particles is referred to in the context of the invention as dust particles SG. The dust particles SG can be suctioned away by a first dust module 10. The first dust module 10 may, as illustrated by way of example in FIG. 1, be arranged on an underside of the power tool 110, and may in particular be mechanically connected to the power tool 110. The first dust module 10 has a dust collecting container 12, which is preferably referred to in the context of the invention as “first dust collecting container”. The dust particles SG can be suctioned via a suction pipe from the working area of the power tool 110 into the first dust module 10, and collected in the dust collecting container 12 of the first dust module 10. The suctioning is effected by a negative pressure, which may be generated by a suction appliance 16 (see FIG. 4) of the first dust module 10. Furthermore, the first dust module 10 may have a filter 14 (see FIG. 2 et seq.) or a filter unit, by means of which the dust-laden air can be filtered before it reaches the suction appliance 16 of the first dust module 10. For the purposes of emptying the dust container 12, the dust module 10 can, in particular in conventional systems, be separated from the power tool 110; the dust module 10 is thus detachably connectable to the power tool 110.

According to the invention, a dust module 10 has a pneumatic, non-lockable interface 50 via which the dust collecting container 12 of the first dust module 10 can be emptied. The interface 50 is preferably provided in the collecting container 12 of the first dust module 10. For this purpose, an inlet contact 29 of a second dust module 20 can be brought into close contact with the interface 50. The second dust module 20 may be an industrial or construction-site vacuum cleaner. The second dust module 20 may also have a suction appliance 26 that can be used to generate a negative pressure. Dust can be suctioned through a suction hose 40 by means of the negative pressure, wherein the suction hose 40 has a front, first end 42 and a rear, second end 44. The suction hose 40 can be connected by way of the rear end 44 to the second dust module 20, whilst a suction nozzle or a power tool 110 can be fastened to the first end 42. The front end 42 of the suction hose 40 may also serve as an inlet contact 29 and be inserted into an opening of the interface 50 of the first dust module 10. In the context of the invention, the insertion of the front suction endhose 42 of the suction hose 40 into the interface 50 is preferably referred to as the establishment of close contact between the dust modules 10, 20. After the suction hose 40 has been connected preferably to the second dust module 20, the front end 42 of the suction hose 40 is preferably also referred to as “inlet contact 29 of the second dust module 20”. In the context of the invention, however, it may also be equally preferred that an inlet contact 29 is arranged directly on the second dust module 20. Here, such an inlet contact 29 that is arranged directly on the second dust module 20 may be formed for example by a protruding hollow cylinder that can be inserted into an opening of the interface 50 in order to open the interface 50 and make it passable to dust. In the context of the invention, the wording “passable to dust” means that dust, dust particles SG and/or dust-laden air can pass through the interface 50 and thus move from the first dust module 10 into the second dust module 20.

In particular, a pressing force can be exerted on the interface 50 by means of the suction hose 40, which pressing force causes the interface 50 to be opened, that is to say made passable to dust-laden air. In other words, dust-laden air or dust particles SG can be suctioned out of the dust collecting container 12 of the first dust module 10 through the opened interface 50. In this way, the collecting container 12 of the first dust module 10 can be emptied in particularly straightforward and uncomplicated fashion. In particular, it is not necessary for this purpose to uninstall the dust collecting container 12 or the entire first dust module 10 from the power tool 110. Rather, the dust collecting container 12 and the first dust module 10 can remain on the power tool 110 when the dust collecting container 12 is emptied. When the interface 50 between the dust modules 10, 20 is open, the dust particles SG can be transferred from the first dust module 10 into the second dust module 20. By virtue of the interface 50 being opened, a suction channel 52 (see, e.g., FIG. 1) can advantageously be formed between the dust modules 10, 20 for the purposes of transferring dust particles SG from one dust module 10 into the other dust module 20. The suction channel 52 preferably runs through the interface 50 and the suction hose 40 and connects the dust collecting containers 12, 22 of the dust modules 10, 20 to one another temporarily—whilst the interface 50 is open.

The second dust module 20 has a filter 24 (see, e.g., FIG. 4) by means of which the dust-laden air can be cleaned before it reaches the suction appliance 26 and is subsequently blown through the outlet opening 28. Furthermore, the second dust module 20 has an inlet opening 27 and an outlet opening 28, wherein the inlet opening 27 and the outlet opening 28 of the second dust module 20 are referred to as “second inlet opening” and “second outlet opening”. Air can be drawn into the second dust module 20 through the inlet opening 27, wherein the suction hose 40 can be connected by way of its rear end 44 to the inlet opening 27. The filtered air can be blown out of the second dust module 20 from the outlet opening 28. The second dust module 20 furthermore has a dust collecting container 22, which may be referred to in the context of the invention as “second dust collecting container”. Dust particles SG can be collected in the second dust collecting container 22. In particular, the dust that is suctioned out of the first dust module 10 via the interface 50 and the suction hose 40 can be collected in the dust collecting container 22 of the second dust module 20.

FIG. 2 shows a sectional illustration of a preferred refinement of the first suction module 10. In particular, FIG. 2 shows the dust collecting container 12, the filter 14 and the interface 50. When the interface 50 is open, dust particles SG can pass from the second dust module 10 into the second dust module 20, wherein, in so doing, the dust particles SG pass in particular through the suction channel 52 that is opened up by the interface 50. It can be made easier for the dust particles SG to be suctioned in from the first dust module 10 in particular by virtue of a stronger negative pressure, that is to say a lower absolute pressure, prevailing in the second dust module 20 than in the first dust module 10. This gives rise, when the interface 50 is open, to an equalizing flow with which the dust particles SG can be suctioned out of the dust collecting container 12 of the first dust module 10.

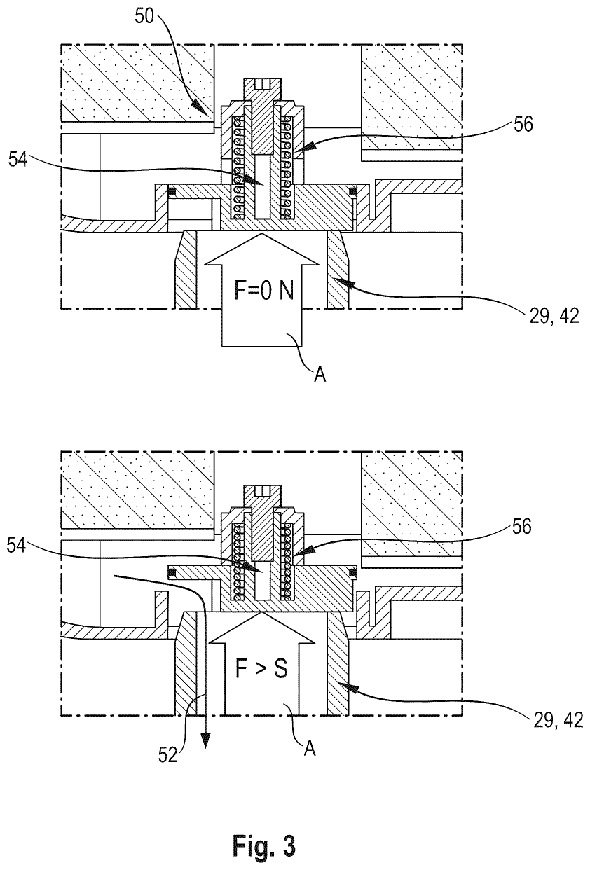

The interface 50 may comprise a valve 54 and a spring element 56, and sealing elements. By way of example, the valve 54 may be designed as a check valve. If the inlet contact 29 of the second dust module 20 is inserted or pushed into an opening of the interface 50, the check valve 54 opens such that dust, dust particles SG and/or dust-laden air can be suctioned out through the interface 50. In the context of the invention, the pushing of the inlet contact 29 into the interface 50 is preferably referred to as the establishment of “close contact” between the inlet contact 29 of the second dust module 20 and the interface 50 of the first dust module 10. In particular, the inlet contact 29 of the second dust module 20 exerts a pressing force F (see FIG. 3) on the check valve 54, such that the valve 54 is moved in the direction of an interior space of the dust collecting container 12 of the first dust module 10. The movement of the valve 54 causes the suction channel 52 to be formed, through which the dust particles SG can pass from the first dust module 10 into the second dust module 20. The interface 50 may furthermore have a spring element 56, by means of which the valve 54 is closed again when the inlet contact 29 is removed from the region of the interface 50 or when there is no longer close contact between the inlet contact 29 of the second dust module 20 and the interface 50 of the first dust module 10.

FIG. 3 shows a sectional illustration of a preferred refinement of the pneumatic, non-lockable interface 50. The upper half of FIG. 3 illustrates the interface 50 in the closed state, whereas the interface 50 is illustrated in the open state in the lower half of FIG. 3. The upwardly pointing arrow represents the pressing force F and its direction. The inlet contact 29 of the second dust module 20 can be inserted into an opening of the first dust module 10 in order to open the interface 50, this opening of the first dust module 10 preferably also being referred to as opening of the interface 50. When the interface 50 is closed, the pressing force F is 0 newtons (N), that is to say the inlet contact 29 of the second dust module 20 exerts substantially no force on the interface 50 or on the valve 54 contained in the interface 50. The spring element 56 of the valve 54 is thus preferably situated in a preloaded state, in which the spring element 56 of the valve 54 is preloaded with a preload force S. The interface 50 is preferably opened by virtue of the inlet contact 29 of the second dust module 20 being brought into close contact with the interface 50 or with the valve 54 in the interface 50. A pressing force F is thus exerted on the interface 50 or on the valve 54, and the valve 54 is opened.

In particular, the valve 54 may be pushed in an upward spatial direction, that is to say preferably in the direction of an interior space of the collecting container 12 of the first dust module 10 in the context of the invention, by the inlet contact 29. As a result of this axial movement of the valve 54, it is in particular also possible for the spring element 56 of the interface 50 to be braced, such that said spring element is in a braced state when the interface 50 is open (see the lower half of FIG. 3). When the interface 50 is in the opened state, a suction channel 52 through the interface 50 is advantageously formed, through which dust particles SG and dust-laden air can be suctioned out of the first dust module 10. In this way, the dust collecting container 12 of the first dust module 10 can be emptied in uncomplicated fashion, and without the need to uninstall the dust module 10. The path of the dust-laden air and of the dust particles SG through the suction channel 52 is indicated in the lower half of FIG. 3 by the curved, downwardly pointing arrow.

Owing to the bracing (preload) of the spring element 56 of the interface 50, the interface 50 can be of self-closing design. When there is no longer close contact between the inlet contact 29 and the interface 50, the spring element 56 preferably relaxes again and, together with the valve 54, closes the suction channel 52. In this way, when the interface 50 is in the closed state, no dust-laden air and no dust particles SG can be exchanged between the dust modules 10, 20.

FIG. 4 schematically shows a preferred refinement of the system 100 having a first dust module 10 and a second dust module 20. The first dust module 10 is illustrated in the upper half of the image, whereas the second dust module 20 is illustrated in the lower half of the image. The preferred refinement of the first dust module 10 illustrated in FIG. 4 has an inlet opening 17 and an outlet opening 18, through which air can be drawn into the dust module 10 and later blown out again. The dust particles SG that are drawn in can be collected in the dust collecting container 12, wherein the non-lockable pneumatic interface 50 may be arranged in the dust collecting container 12. The first dust module 10 furthermore has a filter 14 and a suction appliance 16. The differently filled arrows indicate that a dust content of the air progressively decreases on the path through the dust module 10, be it as a result of the dust remaining in the dust collecting container 12 or as a result of the air passing through the filter 14, where it is filtered such that the dust content decreases.

The second dust module 20 also has an inlet opening 27 and an outlet opening 28, as well as a dust collecting container 22, a filter 24 and a suction appliance 26. By being connected to the second dust module 20, the interface 50 of the first dust module 10 can be opened such that a suction channel 52 is created between the dust modules 10, 20, via which suction channel the dust particles SG can be transferred from the first dust module 10 into the second dust module 20. The suction channel 52 between the dust modules 10, 20 may preferably run through the interface 50 and the suction hose 40. In the context of the invention, it is preferred that the interface 50 has a substantially circular cross section. Other cross-sectional shapes are self-evidently also conceivable, such as an elliptical or an oval cross section. The cross section may self-evidently also be of polygonal, for example rectangular design. If the cross section of the interface 50 is substantially circular, it may be preferred in the context of the invention for a diameter of the interface to lie in a range from 2-6 cm, preferably between 2.5 and 5 cm, and particularly preferably between 3 and 3.8 cm.

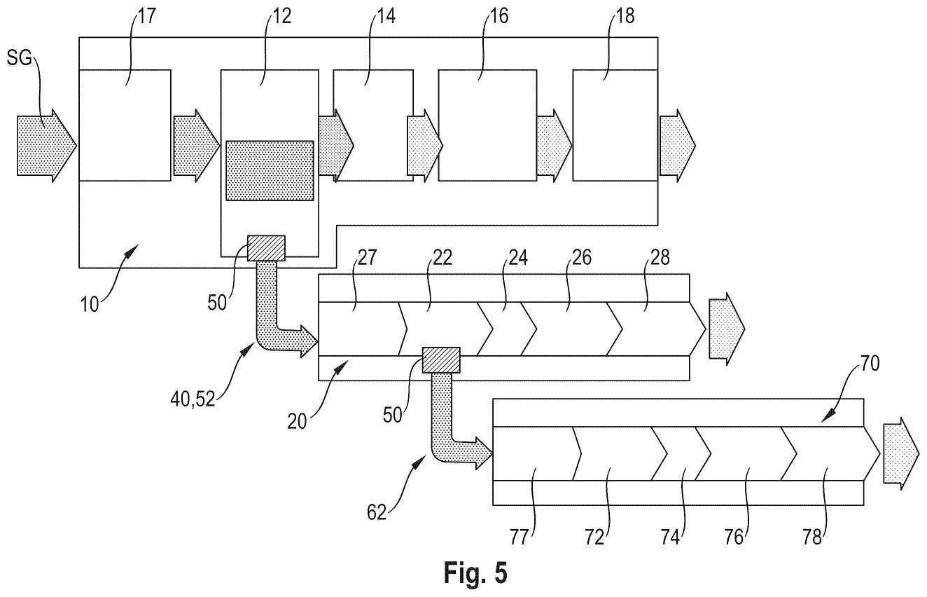

FIG. 5 schematically shows a preferred refinement of the system 100 having a first dust module 10, a second dust module 20 and a third dust module 70, the latter being representative of n further dust modules. The system 100 illustrated in FIG. 5 substantially corresponds to the system 100 shown in FIG. 4. However, the system 100 has been expanded to include a further dust module 70, wherein the additional dust module 70 is representative of a multiplicity of dust modules with which a system 100 consisting of two dust modules 10, 20 can be expanded. For example, a system 100 may comprise two, three, four, five, six, seven, eight or more dust modules. For example, if the system 100 comprises eight dust modules, the dust modules 1 to 7 may each comprise a non-lockable pneumatic interface 50, whilst the eighth dust module serves for receiving the dust particles SG from the dust modules 1 to 7. Here, the dust modules 1 to 7 may preferably be connected to the eighth dust module in succession, such that dust-laden air and the dust particles SG can be transferred from the dust modules 1 to 7 into the eighth dust module. The dust particles SG are preferably transferred using the interface 50 or through the suction channel 52 that is formed between the dust modules 10, 20, 70. In the context of the invention, it may also be preferred for the dust particles SG from the first dust module 10 to be transferred into the second dust module 20, for the dust particles from the second dust module 20 to be transferred into the third dust module 70, and so on. Such a situation is illustrated by way of example in FIG. 5, in which the suction channel that is formed between the second dust module 20 and the further dust module 70 is preferably referred to in the context of the invention as “suction channel 62”. In the exemplary embodiment of the system 100 illustrated in FIG. 5, both the first dust module 10 and the second dust module 20 have an interface 50 for transferring the dust particles SG, whilst in particular the second dust module 20 and the further dust module 70 may have inlet contacts 29 (not illustrated) by means of which the interface of the n−1-th dust module can be opened.

The third or further dust module 70 that is illustrated in FIG. 5 also has an inlet opening 77 and an outlet opening 78, as well as a dust collecting container 72, a filter 74 and a suction appliance 76.

### LIST OF REFERENCE SIGNS

10 First dust module
12 Dust collecting container of the first dust module, “first dust collecting container”
14 Filter in the first dust module
16 Suction appliance in the first dust module
17 Inlet opening of the first dust module
18 Outlet opening of the first dust module
20 Second dust module
22 Dust collecting container of the second dust module, “second dust collecting container”
24 Filter in the second dust module
26 Suction appliance in the second dust module
27 Inlet opening of the second dust module
28 Outlet opening of the second dust module
29 Inlet contact
40 Suction hose
42 Front end of the suction hose
44 Rear end of the suction hose
50 Pneumatic, non-lockable interface
52 Suction channel
54 Valve
56 Spring element
62 Suction channel between the n-th and (n+1)-th dust module
70 n-th dust module
72 Dust collecting container of the n-th dust module, “n-th dust collecting container”
74 Filter in the n-th dust module
76 Suction appliance in the n-th dust module
77 Inlet opening of the first dust module
78 Outlet opening of the first dust module
100 System
110 Power tool
112 Tool of the power tool
F Pressing force
S Preload force

What is claimed is:

1-13. (canceled)

14. A system comprising:
a first dust module having a first dust collecting container for receiving dust particles; and
a second dust module having a second dust collecting container for receiving dust particles;
the first dust module having a non-lockable pneumatic interface for connection to the second dust module, the dust particles suctionable via the interface out of the first dust collecting container of the first dust module.

15. The system as recited in claim 14 wherein the non-lockable pneumatic interface is of self-closing design.

16. The system as recited in claim 14 wherein the non-lockable pneumatic interface is configured to establish a suction channel between the first dust module and the second dust module.

17. The system as recited in claim 16 wherein the suction channel exists only for as long as a pressing force is exerted between the first dust module and the second dust module.

18. The system as recited in claim 16 wherein the non-lockable pneumatic interface includes a valve for opening up or for closing the suction channel.

19. The system as recited in claim 18 wherein the valve is designed as a check valve.

20. The system as recited in claim 14 wherein the non-lockable pneumatic interface is pneumatically activatable by way of close contact or a pressing force.

21. The system as recited in claim 14 wherein the first dust module is a dust collecting box for a power tool or a separate vacuum cleaner, and the second dust module is the other of the dust collecting box for the power tool and the separate vacuum cleaner.

22. The system as recited in claim 21 wherein the non-lockable pneumatic interface is situated in the first dust collecting container of the first dust module.

23. The system as recited in claim 14 wherein the first dust module is emptiable via the interface without being uninstalled.

24. The system as recited in claim 14 wherein the second dust module has an inlet contact bringable into close contact with the non-lockable pneumatic interface of the first dust module such that a suction channel is formed between the first dust module and the second dust module.

25. A pneumatic interface between a first dust module and a second dust module for the purpose of suctioning dust particles out of the first dust module.

14. A method for suctioning dust particles out of a first dust module wherein the first dust module is part of a system as recited in claim 14, the method comprising the following steps:
a) providing the first dust module;
b) connecting the first dust module to the second dust module via the interface; and
c) suctioning the dust particles out of the first dust module via the interface.
